(19) United States
(12) Patent Application Publication
(10) Pub. No.: US 2026/0072117 A1
(43) Pub. Date: Mar. 12, 2026

(54) UWB DEVICE ORIENTATION DETECTOR

(71) Applicant: Google LLC, Mountain View, CA (US)

(72) Inventors: Peter Bevelacqua, Sunnyvale, CA (US); Jerry Weiming Kuo, San Jose, CA (US)

(73) Assignee: Google LLC, Mountain View, CA (US)

(21) Appl. No.: 19/102,348

(22) PCT Filed: Aug. 3, 2023
(86) PCT No.: PCT/US2023/029370

§ 371 Date: Feb. 7, 2025

Related U.S. Application Data
(60) Provisional application No. 63/396,301, filed on Aug. 9, 2022.

(51) Int. Cl. G01S 3/48; G01S 5/02

(52) U.S. Cl. CPC G01S 3/48; G01S 5/0284

(57) ABSTRACT

Techniques for determining relative orientations using radio communications are described. In an example, a computerized device includes a housing, first and second antennas mirror oriented across an axis of the computerized device, and a processing system in communication with the first and second antennas. The phase difference of arrival (PDoA) between the arrival of a radio signal received from a remote device at the first and second antennas, and an angle of arrival (AoA) for the radio signal from the remote device, are determined. Using the PDoA and the AoA, a relative orientation of the remote device with respect to the computerized device is determined and an indication of the relative orientation is outputted.

### CROSS-REFERENCE TO RELATED APPLICATION

This application claims the benefit of and priority to U.S. Provisional Application No. 63/396,301, filed on Aug. 9, 2022, and titled “UWB DEVICE ORIENTATION DETECTOR,” the content of which is herein incorporated by reference in its entirety for all purposes.

### BACKGROUND

Determining a relative orientation of a remote device can be useful for many reasons, including confirming that the correct device has been selected for pairing or accurately rendering a corresponding graphical object at a display with the same orientation as the remote device.

However, determining the relative orientation of a remote device using radio signals alone can be difficult. Embodiments detailed herein provide effective arrangements for accurately determining the relative orientation of a remote device.

### SUMMARY

Various embodiments are described related to determining relative orientations between devices. In some embodiments, a computerized device for determining relative orientation using radio communications is described. The computerized device may comprise a housing comprising a first surface in a first plane. The computerized device may further comprise a first antenna and a second antenna disposed within the housing and distributed along a first axis parallel to the first plane. the first antenna and the second antenna may be a same type, and the first antenna and the second antenna may be mirror oriented across a second axis perpendicular to the first axis and parallel to the first plane. The computerized device may further comprise a processing system, comprising one or more processors, disposed within the housing, and in communication with the first antenna and the second antenna. The processing system may be configured to detect an arrival of a radio signal at the first antenna and the second antenna. The radio signal may be received from a remote device. The processing system may be further configured to determine a phase difference of arrival (PDoA) between the arrival of the radio signal at the first antenna and the second antenna. The processing system may be further configured to determine an angle of arrival (AoA) for the radio signal from the remote device to the computerized device. The processing system may be further configured to determine a relative orientation of the remote device with respect to the computerized device using the PDoA and the AoA. The processing system may be further configured to output an indication of the relative orientation.

In some embodiments, the first antenna and the second antenna both have a linear polarization, the linear polarization of the first antenna is parallel with the linear polarization of the second antenna, and the linear polarization is parallel to the first plane. In some embodiments, the first antenna and the second antenna are planar inverted-F antennas (PIFA). In some embodiments, the first antenna and the second antenna are ultra-wideband (UWB) antennas, and the radio signal is a UWB message. In some embodiments, the first surface comprises an electronic display, the housing further comprises a bezel joining the first surface to a second surface of the housing, and the first antenna and the second antenna are disposed adjacent to the first surface between the electronic display and the bezel.

In some embodiments, determining the relative orientation comprises identifying an orientation entry in a lookup table using the PDoA and the AoA as lookup keys. In some embodiments, determining the relative orientation comprises executing a machine learning model using the PDoA and the AoA as inputs. In some embodiments, the processing system is further configured to determine a type of the remote device, a distance from the computerized device to the remote device, or both. Determining the relative orientation may further comprise using the type of the remote device, the distance from the computerized device to the remote device, or both. In some embodiments, the relative orientation comprises a rotation angle about a third axis perpendicular to the second axis and extending from the computerized device to the remote device. The computerized device may be selected from the group consisting of: a tablet computer; a laptop computer; a hand-held gaming device; and a smartphone.

In some embodiments, a method of determining relative orientations between electronic devices is described. The method may comprise detecting an arrival of a radio signal transmitted by a remote device at a first antenna and a second antenna of a computerized device. The first antenna and the second antenna may be a same type, the first antenna and the second antenna may be distributed along a first axis, and the first antenna and the second antenna may be mirror oriented across a second axis perpendicular to the first axis. The method may further comprise determining a phase difference of arrival (PDoA) between the arrival of the radio signal at the first antenna and the second antenna. The method may further comprise determining an angle of arrival (AoA) for the radio signal from the remote device to the computerized device. The method may further comprise determining a relative orientation of the remote device with respect to the computerized device using the PDoA and the AoA. The method may further comprise outputting an indication of the relative orientation of the remote device.

In some embodiments, the computerized device is in communication with a virtual reality display and the method further comprises rendering, at the virtual reality display using the indication of the relative orientation, a virtual reality object with a same virtual orientation with respect to a perspective of the virtual reality display as the relative orientation of the remote device with respect to the computerized device. In some embodiments, the method further comprises outputting instructions to a user of the computerized device to adjust the relative orientation of the remote device to achieve a second relative orientation, and determining, by the computerized device, that the remote device is in the second relative orientation.

In some embodiments, determining the relative orientation comprises identifying an orientation entry in a lookup table using the PDoA and the AoA as lookup keys. In some embodiments, determining the relative orientation comprises executing a machine learning model using the PDoA and the AoA as inputs. In some embodiments, the method further comprises determining a type of the remote device, a distance from the computerized device to the remote device, or both. Determining the relative orientation may further comprise using the type of the remote device, the distance from the computerized device to the remote device, or both.

In some embodiments, a non-transitory processor-readable medium is described. The medium may comprise processor-readable instructions configured to cause one or more processors to detect an arrival of a radio signal transmitted by a remote device at a first antenna and a second antenna of a computerized device. The one or more processors may further be caused to determine a phase difference of arrival (PDoA) between the arrival of the radio signal at the first antenna and the second antenna. The one or more processors may further be caused to determine an angle of arrival (AoA) for the radio signal from the remote device to the computerized device. The one or more processors may further be caused to determine a relative orientation of the remote device with respect to the computerized device using the PDoA and the AoA. The one or more processors may further be caused to output an indication of the relative orientation of the remote device.

In some embodiments, the first antenna and the second antenna are a same type, the first antenna and the second antenna are distributed along a first axis, and the first antenna and the second antenna are mirror oriented across a second axis perpendicular to the first axis. In some embodiments, the relative orientation is determined by identifying an orientation entry in a lookup table using the PDoA and the AoA as lookup keys. In some embodiments, the relative orientation is determined by executing a machine learning model using the PDoA and the AoA as inputs.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of two devices located near each other for which a relative orientation between the two devices can be determined using ultra-wideband (UWB).

FIG. 2 illustrates an embodiment of a block diagram of a computerized device which can determine the relative orientation of a remote device with respect to the computerized device.

FIG. 3 illustrates an embodiment of an antenna assembly used to determine relative device orientations.

FIG. 4A illustrates the phase difference of arrival (PDoA) at a computerized device in an embodiment where the computerized device and the remote device are in co-polarization.

FIG. 4B illustrates the PDA at a computerized device in an embodiment where the computerized device and the remote device are in cross-polarization.

FIG. 5 illustrates an embodiment of a graph indicating the relationship between PDoA, AOA, and relative device orientation.

FIG. 6 illustrates an embodiment of a method for determining spatial relationships between electronic devices.

FIG. 7 illustrates an embodiment of a method for enabling electronic device functionalities using spatial relationships between electronic devices.

FIG. 8 illustrates an embodiment of a method for controlling a computerized device by a remote device.

FIG. 9 illustrates an embodiment of a method for updating a graphical display based on changes in orientation of a remote device.

FIG. 10 illustrates an example of pairing a remote device with a computerized device in accordance with some embodiments.

FIG. 11 illustrates an example of controlling a computerized device based on movement of a remote device in accordance with some embodiments.

### DETAILED DESCRIPTION

A nearby device can be located using one or more UWB communications to determine a range and to determine an angle of arrival (AoA) from which the UWB communication arrived.

While the range and AoA from a nearby device may be helpful in determining the relative location of a device, new applications of UWB technology may benefit from additional information relating to the orientation of the nearby device. Device orientation can be determined using additional sensors on the nearby device, such as inertial measurement units (IMUs), or on the detecting device, such as one or more cameras or optical sensors. However, using additional sensors to determine the relative orientation of the remote device may lead to an unnecessary amount of power and/or processing resource consumption by either the remote device or the sensing device. For example, using cameras to detect the relative orientation may rely on both power and computing intensive image/object detection and recognition algorithms to determine the relative orientation. While IMUs on the remote device may provide a simpler solution in terms of computational requirements, they rely on the ability of both devices to support additional bandwidth necessary to transmit the measurements between devices.

In contrast to using additional sensors, embodiments detailed herein are focused on using phase difference values between multiple antennas, AoA values from the remote device to the sensing device, and associated lookup tables to determine the relative orientation of the remote device with respect to the sensing device. Such arrangements as detailed herein can have significant benefits, such as not requiring additional sensors on either device, thereby greatly reducing processing and power consumption needs.

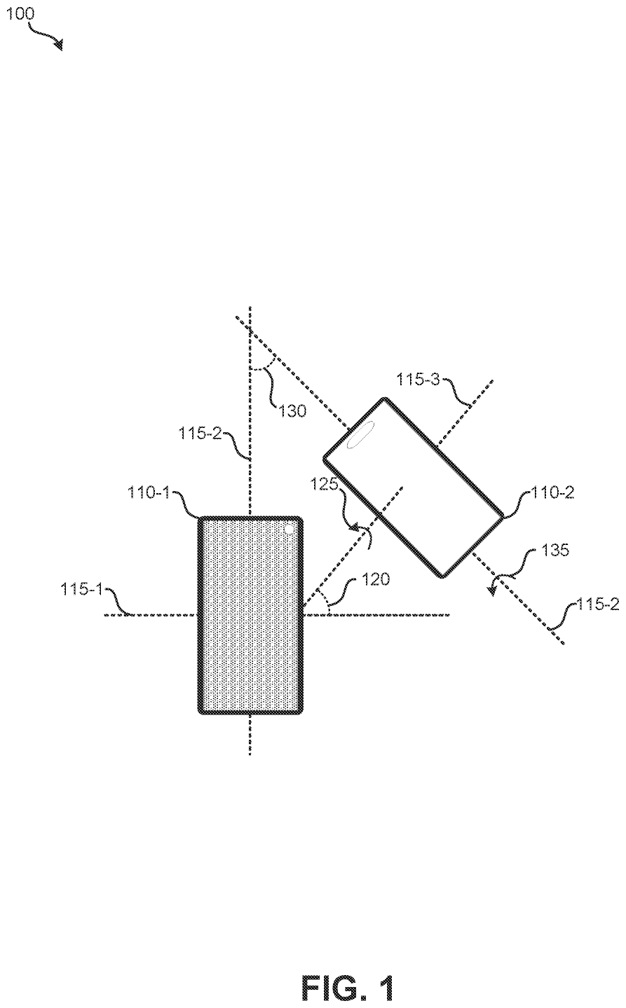

FIG. 1 illustrates an embodiment of a system 100 that includes two devices located near each other for which a relative orientation between the two devices can be determined using ultra-wideband (UWB). System 100 can include computerized device 110-1 and computerized device 110-2. Computerized devices may be various forms of electronic devices, which can use radio signals for communication and/or positioning. Computerized devices 110 can include: tablet computers; laptop computers; gaming devices; smartphones; smart home devices; home assistant devices; smart home hubs; and other forms of computerized devices. In general, embodiments detailed herein can be performed by any form of computerized device on which multiple antennas can be installed with at least a distance of several centimeters between the antennas. Additionally, or alternatively, embodiments detailed herein can be performed by a combination of computerized devices on which multiple antennas are installed in a particular arrangement, as described further below, and computerized devices on which as few as one antenna are installed.

In FIG. 1, computerized device 110-1 may be using one or more radio signals, including UWB messages, transmitted by computerized device 110-2 to determine a direction toward computerized device 110-2 and a relative orientation between computerized devices 110. Generally, UWB communications occur within the range of frequencies of 3.1 GHz-10.6 GHZ; therefore, the band used for UWB communications can be over 7 GHz wide. In other embodiments, such as those in which other radio signals not considered to be UWB are used, the specific frequency range over which communications are sent may vary from this defined range. Implementations of UWB may use a portion of this band, such as a frequency band spanning 500 MHz or more. Generally, UWB can be used for high-speed data transfers (e.g., 1 Gbit/s) over relatively short distances, such as 10 meters. UWB communications may be performed in accordance with IEEE 802.15.4a. While any form of payload data (e.g., files, music, contact cards, video) can be sent via UWB messages, at least some UWB messages include a precise timestamp indicative of a time of transmission. This timestamp can be used to perform a time-of-flight (ToF) analysis to determine a distance from the transmitting device to a recipient device. Additionally, or alternatively, UWB messages may include measurements collected by sensors on the transmitting device including accelerometers, gyroscopes, compasses, barometers, and the like.

Computerized devices 110 may define one or more axes 115 passing therethrough which may be used to describe the relative orientations of computerized devices 110 in three-dimensional space. For example, computerized device 110-1 is illustrated as having a horizontal (x) axis 115-1, as well as a vertical (y) axis 115-2, passing through the respective horizontal and vertical centers, or axes, of rotation of computerized device 110-1. As another example, computerized device 110-2 is illustrated as having vertical (y) axis 115-2, as well as (z) axis 115-3, passing through the respective vertical and (z) centers, or axes, of rotation of computerized device 110-2.

Using the timestamp and performing a ToF analysis, computerized device 110-1 can determine a range (or distance) from an antenna of computerized device 110-2 to an antenna of computerized device 110-1. This distance, however, is not indicative of direction or orientation.

Rather, a separate AoA analysis is performed to determine a direction from computerized device 110-1 to computerized device 110-2. Using one or more received UWB messages from computerized device 110-2, AoA 120 may be determined. As illustrated, AoA 120 may be represented by a single angle. However, in some embodiments, AoA 120 may include additional angles. For example, using three or more antennas that are not colinear, two angles may be resolved. In some embodiments, AoA 120 is determined using a time difference of arrival (TDoA) approach based on the different times at which a UWB message and/or radio signal is received at separate antennas of computerized device 110-1. Additionally, or alternatively, AoA 120 may be determined using one or more pieces of information encoded in the UWB messages transmitted by computerized device 110-2. While AoA 120 is illustrated as an angle based on horizontal (x) axis 115-1, it should be understood that AoA 120 may be translated to being an angle defined from some other axis, such as vertical (y) axis 115-2 or the z-axis of computerized device 110-1. Additionally, or alternatively, AoA 120 may include two angles (e.g., azimuth and elevation) defined from a combination of axes such as horizontal (x) axis 115-1 and vertical (y) axis 115-2.

An additional orientation analysis may be performed to determine the relative orientation of computerized device 110-2 with respect to computerized device 110-1. The relative orientation of a device may be described from the perspective of either device. For example, the relative orientation of computerized device 110-2 may be described from the perspective of computerized device 110-1 as though vertical (y) axis 115-2 of computerized device 110-1 is aligned with acceleration due to gravity and the (z) axis (not illustrated) of computerized device 110-1 is aligned with magnetic north. Using accelerometer and/or gyroscope measurements from sensors included in computerized device 110-1, the relative orientation of computerized device 110-2 with respect to computerized device 110-1 may be translated to real world coordinates or an arbitrary coordinate system. This may be the case when, for example, the axes of computerized device 110-1 are not aligned with gravity and magnetic north, as described above, and/or when attempting to render an object in a virtual reality (VR) or augmented reality (AR) coordinate system.

The relative orientation of a device may include values for roll, pitch, and/or yaw. For example, as illustrated, the relative orientation of computerized device 110-2 with respect to computerized device 110-1 includes roll 125 about (z) axis 115-3. The relative orientation of computerized device 110-2 with respect to computerized device 110-1 may also include yaw 135 about vertical (y) axis 115-2. While not illustrated, the relative orientation of computerized device 110-2 with respect to computerized device 110-1 may further include a pitch angle about a horizontal axis of computerized device 110-2. The values for the roll, pitch, and/or yaw of a device may be expressed by, and/or determined from, the angles at which each particular axis of one device would intersect, if at all, with the corresponding axis of the other device if they were placed in the same plane. For example, roll 125 about (z) axis 115-3 may include angle 130 at which vertical (y) axis 115-2 of computerized device 110-2 intersects with vertical (y) axis 115-2 of computerized device 110-1 when placed in the same plane (x, y) plane (e.g., the plane of the page).

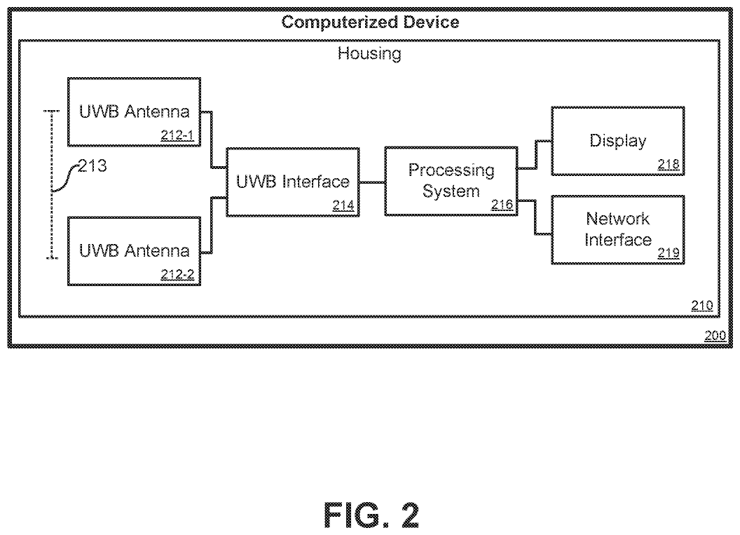

One or more of the computerized devices of FIG. 1 may use the system detailed in FIG. 2 to determine the relative orientation of a remote computerized device that transmitted one or more radio signals, such as UWB messages. FIG. 2 illustrates an embodiment of a block diagram of a computerized device 200 which can determine the relative orientation of a remote device.

Computerized device 200 can represent, for example, computerized device 110-1 and, possibly, computerized device 110-2 of FIG. 1. Computerized device 200 can include: housing 210; UWB antennas 212 which are separated by fixed distance 213; UWB interface 214; processing system 216; display 218; and network interface 219. In other embodiments, fewer or greater numbers of components may be present. For example, inclusion of network interface 219 is not necessary for relative orientation to be determined. Similarly, inclusion of both UWB antennas 212 is not necessary in a device for which relative orientation is to be determined. While described herein as UWB antennas configured to transmit and receive UWB messages, UWB antennas 212 may additionally, or alternatively, include various alternative antennas configured to transmit and receive radio signals with or without data encoded therein.

Housing 210 can house the components of computerized device 200. In some embodiments, housing 210 may be metallic. In some embodiments, rigid or semi-rigid materials, such as plastic or glass, may be used as a part of housing 210. In embodiments detailed herein, at least two UWB antennas 212 are present. Each of UWB antennas 212 are capable of receiving a radio signal in the form of a UWB message from another device. UWB antennas 212 may separately receive the same radio signal from another device. In some embodiments, a single one of UWB antennas 212 is active at a given time. Two UWB antennas 212 may be sufficient for determining a two-dimensional orientation for the device that transmitted the UWB message. In other embodiments, three or more UWB antennas 212, or multiple pairs of UWB antennas 212, may be present to determine additional orientation measurements for the device that transmitted the UWB message.

UWB antennas 212 are separated by fixed distance 213, which can be stored by or otherwise accessible to processing system 216. UWB antennas 212 may come in various forms. In some embodiments, UWB antennas are surface mounted. UWB antennas 212 can use a connector such as a surface mount micro-coaxial jack to be electrically connected with UWB interface 214. UWB antennas can be various types, such as: patch, IFA (inverted-F antenna), PIFA (planar inverted-F antenna), loop, dipole, or a hybrid of these types. UWB antennas 212 can be mounted to an inner surface of computerized device 200, part of a main logic board (MLB), integrated with a speaker, or part of a slot in the housing that may or may not have a secondary function (such as a rubber foot to hold the device in place). UWB antennas 212 may also be coupled with WiFi antennas, Thread antennas, Bluetooth antennas, and/or cellular antennas. That is, multiband antennas can be used that diplex signals to the appropriate interfaces.

UWB interface 214 can separately receive and process UWB messages via UWB antenna 212-1 and UWB antenna 212-2. In some embodiments, a separate UWB interface is present for each of UWB antennas 212. UWB interface 214 can receive the raw radio frequency (RF) signals via UWB antennas 212 and process such RF signals into digital data to be passed to processing system 216. In some embodiments, UWB interface 214 can be incorporated as part of processing system 216.

Processing system 216 can include one or more processors. Processing system 216 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD).

Processing system 216 may be able to transmit data via UWB antenna 212-1, UWB antenna 212-2, or both via UWB interface 214. Processing system 216 may also be able to output information for presentation to display 218. For example, after processing one or more UWB messages received via UWB antennas 212, processing system 216 may determine the relative orientation of a transmitting device and output an indication of the relative orientation on display 218. Display 218 can vary by embodiment; in some embodiments, a color LED, OLED, AMOLED, or LCD display panel is used.

Processing system 216 may further be in communication with network interface 219, which can allow for communication via one or more wired or wireless networks. Network interface 219 can use a wireless local area network (WLAN) communication protocol such as Wi-Fi. Network interface 219 may more generally use any of the IEEE 802.11 suite of protocols. Network interface 219 may be able to communicate via a mesh network, such as using Matter and/or Thread communication protocols. Other possible protocols that can be used by network interface 219 include short-range device-to-device communication protocols, such as Bluetooth. For a wired communication protocol, network interface 219 may communicate using Ethernet.

Processing system 216 may perform the substantive calculations as to range, AoA, and relative orientation of a transmitting device. In some embodiments, the functionality to determine range, AoA, and relative orientation based on one or more UWB messages can be performed by UWB interface 214. In some embodiments, UWB interface 214 is a separate one or more integrated circuits (ICs) in communication with processing system 216. Alternatively, UWB interface 214 may be incorporated as part of a system-on-a-chip (SOC) design that combines processing system 216 and UWB interface 214.

While not illustrated, other output devices may be presented as part of computerized device 200, such as an audio output device (e.g., headphone jack, wireless headphone interface, speaker) or a haptic feedback device that outputs vibrations. Such output devices can also be used to output AoA and relative orientation information, such as sound that appears to come from the direction of the AoA, or a number of vibrations to indicate relative orientation (e.g., one pulse of vibrations for clockwise roll, two pulses for counter-clockwise roll).

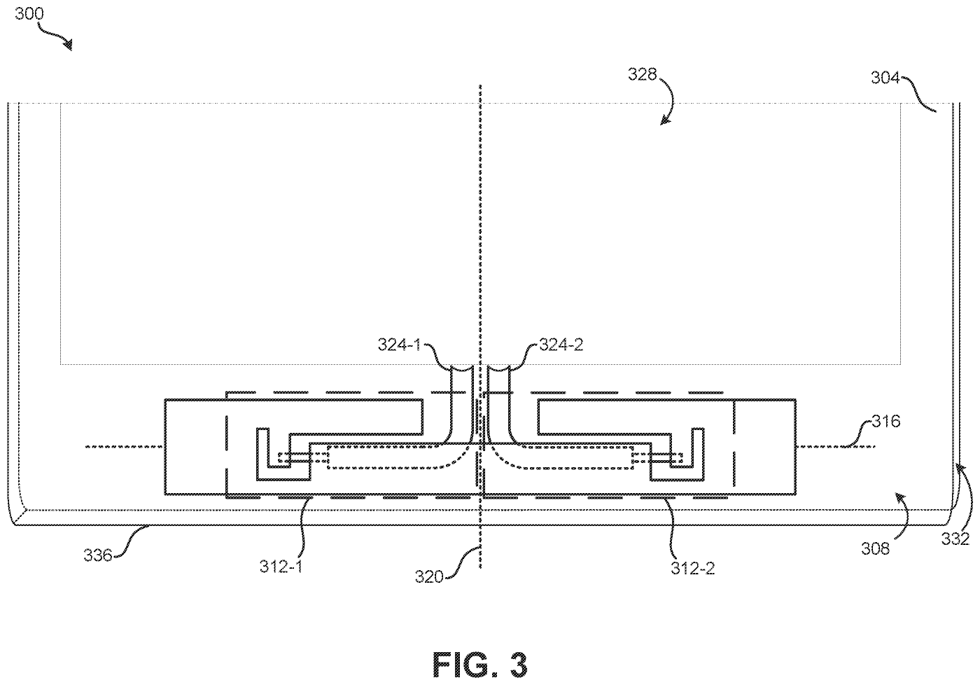

FIG. 3 illustrates an embodiment of a computerized device 300 including an antenna assembly used to determine relative device orientations. Computerized device 300 can represent, for example, computerized device 110-1 and, possibly, computerized device 110-2 of FIG. 1. While not illustrated, computerized device 300 can include one or more components that function in the same, or a similar manner, as computerized device 200 described above. For example, computerized device 300 may include a radio interface, such as UWB interface 214; a processing system, such as processing system 216; and a network interface, such as network interface 219.

Computerized device 300 can include housing 304. Housing 304 can include the exterior materials of computerized device 300. Housing 304 may be metal, glass, plastic, or any combination of materials. Housing 304 may include one or more sections or regions of materials configured to allow electromagnetic waves to pass therethrough. Housing 304 can include first surface 308. First surface 308 may be a front or back face of computerized device 300. For example, first surface 308 may include the front-side-face of an electronic device such as a tablet computer. First surface 308 may define a first plane coplanar with first surface 308. In some embodiments, first surface 308 is flat or substantially planar.

First surface 308 may include electronic display 328. Electronic display 328 can vary by embodiment; in some embodiments, a color LED, OLED, AMOLED, or LCD display panel is used. In some embodiments, electronic display 328 is a touch screen configured to enable a user to navigate between and/or select one or more user interface options displayed on electronic display 328. Additionally, or alternatively, first surface 308 may include one or more buttons and/or user interface devices. For example, first surface 308 may include one or more buttons configured to enable a user to navigate through various user interfaces, such as a “home”, “back”, and/or “select” button.

Housing 304 may further include second surface 332. Second surface 332 may be an edge or side of computerized device 300. Second surface 332 may be a flat or curved surface adjacent first surface 308 and another surface, such as a back-side-face of computerized device 300. Second surface 332 may include one or more buttons and/or one or more openings. Housing 304 may include bezel 336 joining first surface 308 to second surface 332.

Computerized device 300 may include antennas 312 (e.g., first antenna 312-1 and second antenna 312-2) disposed within housing 304. In some embodiments, antennas 312 are the same type of antenna. For example, first antenna 312-1 and second antenna 312-2 may each be planar inverted-F antennas (PIFAs). While described herein as PIFAs, antennas 312 may include alternative types of antennas, such as other planar, patch, and/or printed antennas. In some embodiments, antennas 312 are UWB antennas, as described above. Antennas 312 may be substantially identical. In some embodiments, antennas 312 are linearly polarized. For example, first antenna 312-1 and second antenna 312-2 may be horizontally or vertically polarized. In some embodiments, the polarizations of first antenna 312-1 and second antenna 312-2 are parallel with each other. While described as having a linear polarization, antennas 312 may be configured to provide alternative polarizations, such as circular or elliptical polarization.

Computerized device 300 may include fewer or more than two antennas 312 as described above. For example, computerized device 300 may include an additional one, two, or more pairs of antennas to provide additional accuracy for device orientation determinations and/or to provide dedicated measurements for respective rotational axes, as described above. Antennas 312 may be in communication with an antenna interface, such as UWB interface 214 described above, via wires 324 (e.g., first wire 324-1 and second wire 324-2).

As illustrated, first antenna 312-1 and second antenna 312-2 are distributed along first axis 316. First axis 316 may be parallel to the first plane defined by first surface 308. In some embodiments, the linear polarization of antennas 312 is parallel to the first plane defined by first surface 308. As further illustrated, first antenna 312-1 and second antenna 312-2 are mirror oriented across second axis 320. Second axis 320 is perpendicular to first axis 316 and may be parallel to the first plane defined by first surface 308. Mirror orientation may mean that for every point at a set distance perpendicular to a plane or axis, such as second axis 320, there is an identical point at the set distance perpendicular to the plane or axis on the opposite side of the plane or axis. Stated differently, first antenna 312-1 and second antenna 312-2 may be in mirror orientation when they are distributed such that they form a mirror image of each other with reference to second axis 320. In some embodiments, antennas 312 are disposed adjacent to first surface 308 between electronic display 328 and bezel 336.

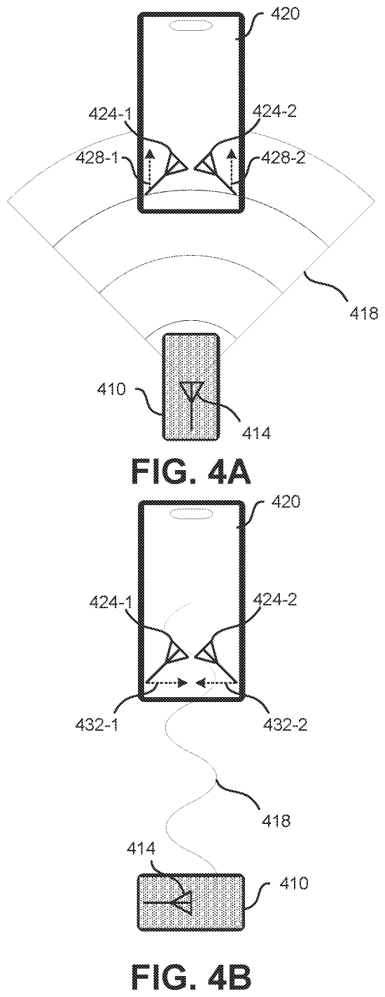

FIGS. 4A and 4B illustrate embodiments of how PDoA measurements can be used to determine relative orientation between two devices. As illustrated, remote device 410 may transmit radio signal 418 using one or more antennas, such as antenna 414, as described above. While illustrated and described as having a linear polarization, antenna 414 may instead have a circular, elliptical, or other suitable polarization. Antenna 414 may be vertically polarized, horizontally polarized, or some angle in between vertical and horizontal, with respect to the reference frame of remote device 410. For example, as illustrated, the linear polarization of antenna 414 may be parallel with a vertical axis of remote device 410. Depending on the orientation of remote device 410, and thus the orientation of antenna 414, radio signal 418 may be vertically polarized, as illustrated in FIG. 4A, horizontally polarized, as illustrated in FIG. 4B, or some angle in between vertical and horizontal, with respect to one or more reference planes, such as the horizon and/or a reference plane of another device, such as computerized device 420.

Computerized device 420 may detect the arrival of radio signal 418 transmitted by remote device 410 at one or more antennas 424, such as first antenna 424-1 and second antenna 424-2. While illustrated and described as having linear polarizations, antennas 424 may instead have a circular, elliptical, or other suitable polarization. Antennas 424 may be vertically polarized, horizontally polarized, or some angle in between vertical and horizontal, with respect to a reference frame of computerized device 420.

The polarization of antenna 414 and/or antennas 424 may be described as having a first polarization component parallel with a first axis and a second polarization component perpendicular to the first axis. In some embodiments, antennas 424 are mirror oriented with respect to one another, as further described above. For example, as illustrated, antennas 424 may be mirror oriented across a vertical axis of computerized device 420. While described herein as being mirror oriented across a vertical axis of computerized device 420, antennas 424 may be mirror oriented across a horizontal axis of computerized device 420 or any other suitable axis such as a slant axis defined by an axis bisecting the vertical and horizontal axes of computerized device 420. Additionally, or alternatively, computerized device 420 may include multiple pairs and/or sets of antennas 424 each mirror oriented across respective axis. For example, while first antenna 424-1 and second antenna 424-2 may be mirror oriented across a vertical axis, additional pairs of antennas 424 may be mirror oriented across a horizontal axis perpendicular to the vertical axis, a z-axis perpendicular to both the vertical and horizontal axes, and/or an arbitrary axis defined with respect to computerized device 420 or another suitable reference frame.

For two antennas mirrored across a mirroring axis, the polarization component of each antenna parallel to the mirroring axis will have the same phase response at 0 degrees AoA from a transmitting antenna to the mirroring axis. For example, as illustrated in FIG. 4A, first polarization component 428-1 of first antenna 424-1, and first polarization component 428-2 of second antenna 424-2, parallel with the vertical axis of computerized device 420, will have the same phase response when receiving radio signal 418 transmitted by antenna 414. Conversely, the polarization component perpendicular to the mirroring axis will have opposite phase responses at 0 degrees AoA from a transmitting antenna to the mirroring axis. For example, as illustrated in FIG. 4B, second polarization component 432-1 of first antenna 424-1, and second polarization component 432-2 of second antenna 424-2, perpendicular to the vertical axis of computerized device 420, will have opposite phase responses when receiving radio signal 418 transmitted by antenna 414.

At any point in time at which computerized device 420 detects radio signal 418 from remote device 410, computerized device 420 may determine the PDoA of radio signal 418 between first antenna 424-1 and second antenna 424-2 based on the phase responses at each antenna. Computerized device 420 may also determine the AoA for radio signal 418 from remote device 410 to computerized device 420. As illustrated, the AoA from remote device 410 to computerized device 420 is 0 degrees (e.g., boresight). Using the PDoA, the AoA, and the principles described above with respect to mirror oriented antennas, computerized device 420 may determine the relative orientation of remote device 410 with respect to computerized device 420, as further described below.

FIG. 4A illustrates an embodiment in which the relative orientation of remote device 410 with respect to computerized device 420 is such that the vertical (y) axes of computerized device 420 and remote device 410 are parallel. As further illustrated in FIG. 4A, antenna 414, with a linear polarization parallel to the vertical (y) axis of remote device 410, produces radio signal 418 with an electrical field in a vertical direction (e.g., with respect to the vertical (y) axis) into and out of the page, indicated by the arced lines. As further illustrated, the linear polarization of antenna 414 is parallel with both of first polarization component 428-1 of first antenna 424-1 and first polarization component 428-2 of second antenna 424-2. Because the linear polarization of antenna 414 is parallel with first polarization components 428, and first polarization components 428 will have the same phase response, the PDoA of radio signal 418 at computerized device 420 will be approximately 0 degrees.

FIG. 4B illustrates an embodiment in which the relative orientation of remote device 410 with respect to computerized device 420 is such that the vertical (y) axes of computerized device 420 and remote device 410 are perpendicular. As illustrated in FIG. 4B, antenna 414, with a linear polarization parallel to the vertical (y) axis of remote device 410, produces radio signal 418 with an electrical field in a horizontal direction across the page. In this arrangement, the linear polarization of antenna 414 is parallel with both of second polarization component 432-1 of first antenna 424-1 and second polarization component 432-2 of second antenna 424-2, such that second polarization components 432 will have opposite phase responses. Because the linear polarization of antenna 414 is parallel with second polarization components 432, and second polarization components 432 will have the opposite phase responses, the PDoA of radio signal 418 at computerized device 420 will be approximately 180 degrees.

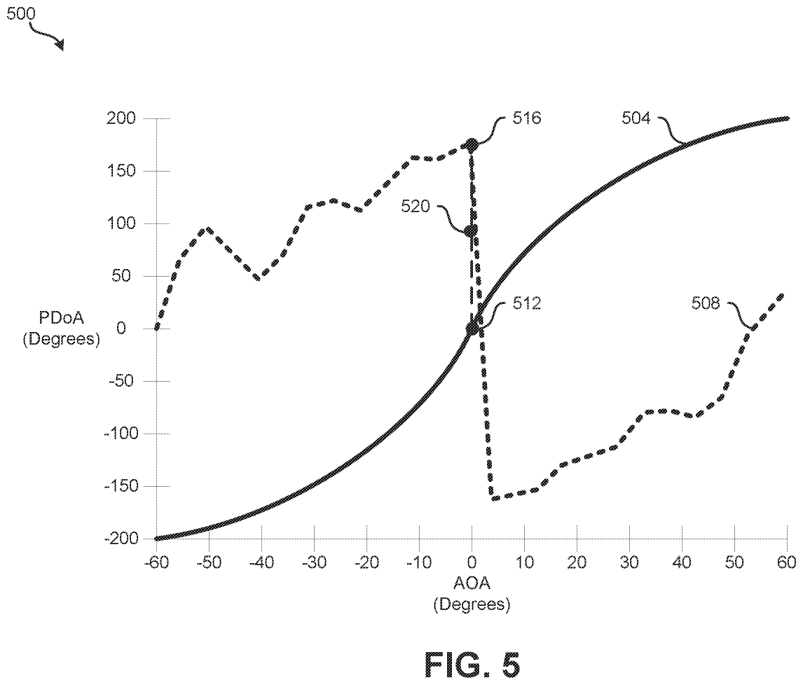

FIG. 5 illustrates exemplary relationships between PDoA, AoA, and relative device orientation. Graph 500 illustrates co-polarization plot 504 and cross-polarization plot 508 for the PDoA of a radio signal detected by two antennas as a function of the AoA in degrees from the source of the radio signal to the two antennas. Co-polarization plot 504 and cross-polarization plot 508 may occur when the two antennas detecting the radio signal are mirror oriented, as further described above in relation to FIGS. 3-4B. Co-polarization plot 504 may be representative of the PDoA detected between two antennas of a device in co-polarization with the antenna of the transmitting device, as illustrated in FIG. 4A above. For example, as illustrated at first point 512, when the AoA from co-polarized remote device 410 to computerized device 420 is 0 degrees, the PDoA may be approximately 0 degrees. Similarly, cross-polarization plot 508 may be representative of the PDoA detected between two antennas of a device in cross-polarization with the antenna of the transmitting device, as illustreated in FIG. 4B above. For example, as illustrated at second point 516, when the AoA from cross-polarized remote device 410 to computerized device 420 is 0 degrees, the PDoA between the two antennas may be approximately 180 degrees.

As the magnitude of the AoA from the transmitting device to the receiving device increases, a change in the corresponding PDoA for co-polarized devices, as indicated by co-polarization plot 504, and cross-polarized devices, as indicated by cross-polarization plot 508, may be observed. For example, as the AoA between co-polarized remote device 410 to computerized device 420 approaches approximately plus or minus 60 degrees, the PDoA, as indicated by co-polarization plot 504 may approach approximately negative plus or minus 200 degrees. In a similar fashion, varying the relative orientation from co-polarization to cross-polarization between devices while maintaining the same AoA may result in a detectable change to the PDoA between the antennas of the receiving device. For example, when the relative orientation of remote device 410 with respect to computerized device 420 is approximately halfway between co-polarization and cross-polarization and the AoA from remote device 410 to computerized device 420 is approximately 0 degrees (e.g., boresight), the PDoA may be approximately 90 degrees, as indicated at third point 520.

Accordingly, when the AoA from the transmitting device to the receiving device is known, the AoA and the detected PDoA between two antennas of the receiving device may be used to determine the relative orientation of the transmitting device with respect to the receiving device. For example, when it is subsequently determined that the AoA from remote device 410 to computerized device 420 is zero degrees, and the detected PDoA between antennas 424 of computerized device 420 of zero degrees, it may be determined that the relative orientation of remote device 410 with respect to computerized device 420 is such that the vertical (y) axes of each device are parallel (e.g., in co-polarization). As another example, when it is determined that the AoA from remote device 410 to computerized device 420 is 0 degrees, and the detected PDoA between antennas 424 of computerized device 420 is approximately 180 degrees, it may be determined that the relative orientation of remote device 410 with respect to computerized device 420 is such that the vertical (y) axes of each device are perpendicular (e.g., in cross-polarization). Additionally, when it is determined that the AoA from remote device 410 to computerized device 420 is 0 degrees, and the detected PDoA between antennas 424 of computerized device 420 is approximately 90 degrees, it may be determined that the relative orientation of remote device 410 with respect to computerized device 420 is such that the vertical (y) axis of remote device 410 is approximately 45 degrees offset from the vertical (y) axis of computerized device 420. While described from the perspective of a 0 degree AoA, similar determinations may be made for a range of AoAs, such as from negative 60 degrees to positive 60 degrees AoA.

In some embodiments, the relative orientation of a remote transmitting device with respect to the receiving device is determined using one or more lookup tables. For example, a one-dimensional lookup table or array may be created using PDoA values measured for each relative orientation between two devices at a particular AoA. Additional lookup tables may then be created for each possible AoA between the two devices. Alternatively, a single two-dimensional table including both PDoA and AoA as keys to corresponding orientation entries may be used. Thereafter, once a computerized device detects a PDoA between its two antennas and determines the AoA from the remote device to the computerized device, the AoA may be used to identify the appropriate lookup table (e.g., using multiple one-dimensional tables) or row (e.g., using a single two-dimensional table) and the PDoA may be used as a key to identify the corresponding orientation entry that produces that particular PDoA at that particular AoA. Additionally, or alternatively, lookup tables, or sets of lookup tables, may be created as necessary for additional antenna pairs of the computerized device to support orientation determinations for each available axis of rotation (e.g., one each for roll, pitch, and yaw). Similarly, lookup tables, or sets of lookup tables, may be created for variations in possible transmitting antenna designs or transmitting devices. For example, different sets of orientation tables may be created for different mobile phone models or for different remote control devices.

In some embodiments, the relative orientation of a remote transmitting device with respect to the receiving device is determined using artificial intelligence (AI) and/or machine learning (ML). For example, collections of PDoA and AoA data collected for various relative orientations of a remote device with respect to a computerized device may be used to train one or more classifiers. Thereafter, once a computerized device detects a PDoA between two antennas and determines the AoA from the remote device to the computerized device, a trained AI/ML classifier may predict the relative orientation of the remote device with respect to the computerized device.

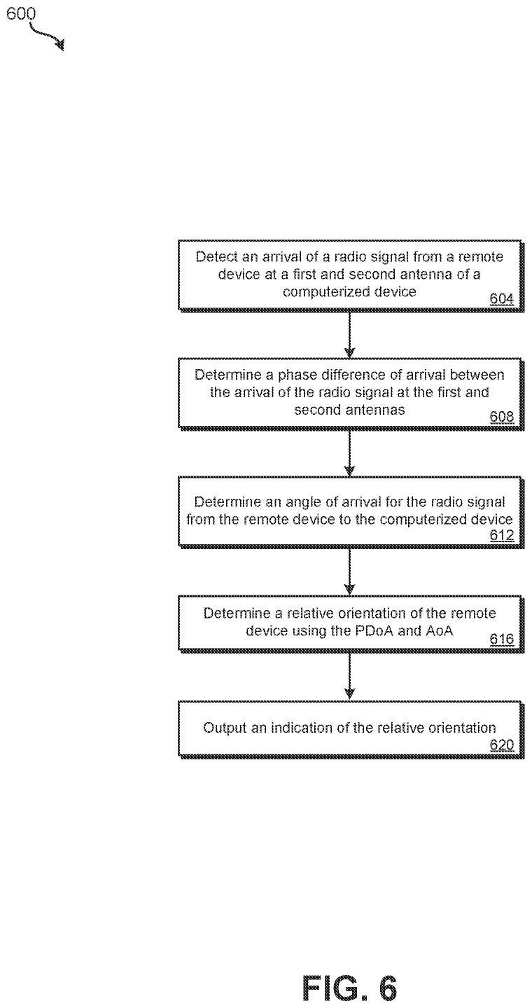

Various methods may be performed using the systems and arrangements of FIGS. 1-5. FIG. 6 illustrates an embodiment of a method 600 for determining spatial relationships between electronic devices. Method 600 may be performed using computerized device 200 or some other form of computerized device having at least two antennas, as described above.

At block 604, an arrival of a radio signal transmitted by a remote device may be detected at a first antenna and a second antenna of a computerized device. The computerized device may be the same, or function in a similar manner, as computerized device 200 and/or computerized device 300 described above. The first antenna and the second antenna may be the same type of antenna, such as a PIFA antenna. In some embodiments, the radio signal is a UWB message and the first and second antennas are UWB antennas. The first antenna and the second antenna may be distributed along a first axis and mirror oriented across a second axis perpendicular to the first axis. In some embodiments, the radio signal transmitted by the remote device is detected at one or more additional pairs of antennas of the computerized device. For example, the computerized device may include three or more pairs of antennas, each associated with a respective rotational axis of the computerized device.

At block 608, a PDoA between the arrival of the radio signal at the first antenna and the second antenna may be determined. The PDoA may be measured by an antenna interface of the computerized device, such as UWB interface 214, as described above. In some embodiments, one or more additional PDoAs are determined for respective pairs of antennas of the computerized device.

At block 612, an AoA for the radio signal from the remote device to the computerized device may be determined. The AoA may be determined using one or more pieces of information from the radio signal. For example, timestamps encoded in the radio signal may be used to calculate the ToF from the remote device each of the first and second antennas. Subsequently, a TDoA analysis may be used to determine the AoA from the remote device to the computerized device.

At block 616, a relative orientation of the remote device with respect to the computerized device may be determined using the PDoA and the AoA. The relative orientation of the remote device may include one or more values representing the relative angular deviation from a corresponding rotational axis, or a coordinate system, of the computerized device. For example, the relative orientation of the remote device may indicate the roll, pitch, and/or yaw of the remote device from the perspective of the computerized device. In some embodiments, the relative orientation of the remote device may be translated from the perspective of the computerized device to align with acceleration due to gravity and magnetic, or true, north. The computerized device may perform this translation using one or more sensor measurements collected from sensors, such as an accelerometer and/or gyroscope, of the computerized device.

At block 620, an indication of the relative orientation of the remote device may be output. The computerized device may output the indication of the relative orientation of the remote device at an electronic display in communication with the computerized device. For example, the electronic display may render a one, two, or three-dimensional representation of the remote device rotated about one or more rotational axes based on the determined relative orientation of the remote device.

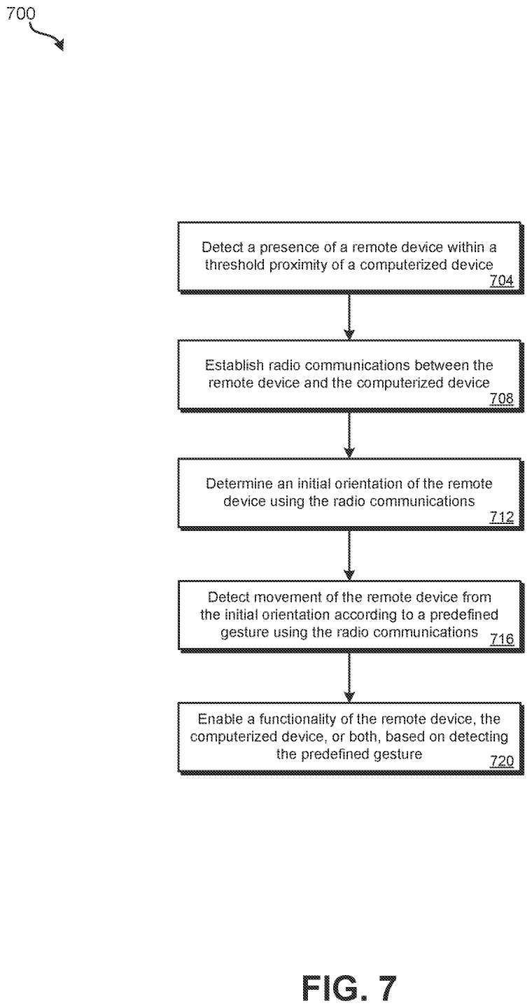

FIG. 7 illustrates an embodiment of a method 700 for enabling electronic device functionalities using spatial relationships between electronic devices. Method 700 may be performed using computerized device 200 or some other form of computerized device configured to determine the spatial relationship between itself and a remote device. However, it should be understood that either or both devices described in method 700 may be capable of determining the spatial relationship between the devices.

At block 704, a presence of a remote device may be detected within a threshold proximity of a computerized device. In some embodiments, the computerized device is a fixed or stationary device. For example, the computerized device may be a device designed to remain substantially stationary during its operation, such as a television, a speaker, a hub device, laptop computer, and the like. As another example, the computerized device may be a device designed to be permanently or semi-permanently fixed to a structure, such as a thermostat, smart lock, physical access control device, smart doorbell, security camera, garage door opener, smart appliance, and the like. In yet another example, the computerized device may be integrated into a vehicle, such as a car, truck, bus, and the like. In some embodiments, the remote device is a mobile device, such as a smartphone, smart watch, key fob, location beacon, and the like.

The computerized device, the remote device, or both, may detect the respective presence of the other device using one or more types of wireless communications (e.g., via Wi-Fi, Bluetooth®, mesh network, UWB, etc.). For example, the remote device and/or the computerized device may emit UWB signals at periodic or semi-periodic signals selected to provide a situational awareness of other UWB enabled devices in the surrounding environment. Upon detecting the presence of another UWB enabled device, either or both devices may determine the distance between the devices and/or a heading from either device to the other. Based on the distance between the devices, it may be determined whether the remote device is within the threshold proximity of the computerized device.

The threshold proximity may be selected based on the intended environment, functionality of the remote device and/or the computerized device, and/or user convenience. For example, the threshold proximity for a computerized device used to control operation of a physical access point, such as a door, elevator, and the like, may be selected to be far enough away from the computerized device to allow users with enough time to authenticate themselves using the remote device while approaching the computerized device. Likewise, the threshold proximity may be selected to be close enough to the computerized device to avoid interference with other remote or computerized devices in the environment, such as another user attempting to authenticate with another computerized device.

At block 708, radio communications may be established between the remote device and the computerized device. Establishing radio communications may include initiating UWB communication between the remote device and the computerized device. Additionally, or alternatively, establishing radio communications may include adjusting or increasing existing radio communications between the remote device and the computerized device. For example, in response determining that the remote device is within the threshold proximity of the computerized device, a frequency of UWB communications between the remote device and the computerized device may be increased from a first frequency used to estimate the distance between the devices to a second frequency selected to provide greater spatial awareness.

At block 712, an initial orientation of the remote device may be determined using the radio communications. The initial orientation of the remote device may be determined with respect to the computerized device, as described above, a real-world reference frame, and/or another reference frame of the environment within which the remote device and the computerized device are located. In some embodiments, the initial orientation may include information about the distance and direction from the remote device to the computerized device, or vice versa. Determining the initial orientation may include performing a ToF AoA/distance measurement and/or a PDoA orientation measurement, as described above in relation to method 600.

In some embodiments, determining the initial orientation includes determining that the remote device is in a predefined orientation. Predefined orientations may be with respect to the computerized device. For example, a predefined orientation associated with establishing a pairing with and/or initiating control of the computerized device by a mobile device, such as a smart phone, may be such that a vertical axis of the mobile device is substantially parallel with acceleration due to gravity and a horizontal axis passing through a screen of the mobile device is substantially parallel with a heading between the mobile device and the computerized device. As used herein, a determination that an axis is substantially parallel with a reference axis, vector, and/or heading may include a determination that the axis is within a threshold angular deviation of the reference axis, vector, and/or heading, such as within 5 degrees, 10 degrees, 15 degrees, and the like.

At block 716, movement of the remote device from the initial orientation according to a predefined gesture may be detected using the radio communications. A gesture may be a predefined continuous movement of the remote device from the initial orientation to a subsequent orientation and/or position. For example, a rotational gesture may include a continuous rotation of the remote device about one or more of its axes, such as a rotation from a starting orientation in which a vertical axis of the remote device is perpendicular to a reference plane to an ending orientation in which the vertical axis is parallel with the reference plane. Gestures may also include translational movement, such as forward, backward, and/or side-to-side movement. For example, a gesture performed with the remote device may include rotation of the remote device around one or more of its axes while moving the remote device along one or more of its axes.

In some embodiments, gestures include two or more motions in a sequence (e.g., rotations and/or translations). For example, a sequence of translational movements may include a linear translation in a first direction, followed by an angular rotation in a second direction, and ending with linear translation in a second direction opposite the first direction. Additional or alternative sequences of gestures may be defined and used in accordance with embodiments described herein.

In some embodiments, gestures are predefined for various functionalities of the computerized device. For example, as described further herein, a computerized device capable of media playback may have predefined gestures associated with all or a subset of the controllable media playback functionalities of the computerized device. Additionally, or alternatively, computerized devices may have unique gestures associated with the device in particular, similar to a unique device identifier. For example, a gesture used to initiate a connection or control over a first device may be differentiated from a gesture used to initiate a connection with, or control, another device within an environment, regardless of the user (e.g., in the case of two identical speakers). In some embodiments, gestures may be associated with a particular remote device or a particular user or their associated user account. For example, a user may define a unique gesture, similar to a unique passcode, with which the computerized device can authenticate the presence of the particular user and determine a level of access or control previously granted to the user. In this way, the user can gain access to and/or control the computerized device assigned to them using any remote device.

Various approaches may be employed to detect the movement of the remote device according to the predefined gesture using the radio communications. For example, continuous ToF AoA/distance measurements and/or PDoA orientation measurements, as described above, may be used to detect movements of the remote device over time. Using radio signals received from the remote device at a predefined frequency, the computerized device can measure changes in the relative orientation and/or position of the remote device over time. For example, changes in the orientation of the remote device over time may be analyzed to detect ongoing and/or completed rotational movements. Based on angular differences between successive orientation measurements, it may be determined that the remote device is being rotated as well as the direction of rotation. By detecting a change in the direction of rotation (e.g., from clockwise to counterclockwise) between successive orientation measurements, and/or by determining that the rate of change in rotation across a number of successive orientation measurements is less than a predefined threshold, it may be determined that a rotational movement has been completed, such as a quarter-turn clockwise rotation. Similarly, using differences in headings between successive AoA measurements and/or distance measurements, it may be determined that the remote device is experiencing translational motion as well as the direction of the translation (e.g., from side-to-side or front-to-back). By detecting a change in the direction of the translation (e.g., a change from left-to-right to right-to-left), and/or by determining that the rate of change in translation across successive measurements is less than a predefined threshold, it may be determined that a translational movement has been completed, such as a movement from left-to-right.

At block 720, a functionality of the remote device, the computerized device, or both may be enabled based on the detection of the predefined gesture. For example, in response to determining that the remote device has been moved according to a predefined gesture associated with a user account having appropriate authorization, an access control device, such as a smart lock, may disengage a locking mechanism, thereby allowing a user of the remote device to operate the access point (e.g., open a door, operate an elevator, etc.) controlled by the access control device. As another example, in response to determining that the remote device has been moved according to a predefined gesture associated with initiating control of the computerized device by the remote device, subsequent gestures performed with the remote device, and detected by the computerized device, may be used to control one or more functionalities of the computerized device, such as one or more media playback and/or graphical rendering functionalities, as described further herein.

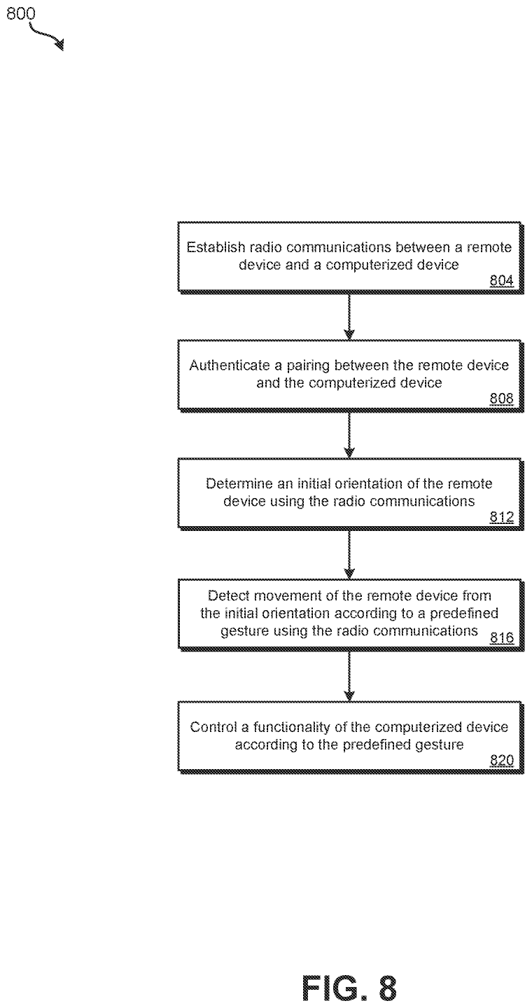

FIG. 8 illustrates an embodiment of a method 800 for controlling a computerized device by a remote device. Method 800 may be performed using computerized device 200 or some other form of computerized device configured to determine the spatial relationship between itself and a remote device. However, it should be understood that either or both devices described in method 800 may be capable of determining the spatial relationship between the devices. Method 800 may optionally include some or all of the steps described above in relation to method 600 and/or method 700.

At block 804, radio communications may be established between the remote device and the computerized device. The remote device and the computerized device may be the same, or similar, devices as described above in relation to method 700. For example, the remote device may be a mobile device, such as a smartphone or smartwatch, and the computerized device may be a substantially stationary and/or fixed device, such as a smart television, smart thermostat, smart speaker, hub device, and the like. Radio communications may be established as described above in relation to block 704 and/or block 708. For example, after determining that the remote device is within a threshold proximity of the computerized device, radio communications, such as UWB communications, may be established between the remote device and the computerized device. Additionally, or alternatively, radio communications may already be established as a result of executing a preceding method, such as method 700.

At block 808, a pairing between the remote device and the computerized device may be authenticated. Authenticating the pairing between the remote device and the computerized device may include verifying that the remote device, or a user account associated with a user of the remote device, is authorized to connect with and/or control the computerized device. For example, using the established radio communications (e.g., UWB communications), and/or one or more alternative types of wireless communication, such as WiFi, Bluetooth®, Near Field Communication (NFC), and the like, the remote device can transmit a device and/or user identifier to the computerized device for authentication. Additionally, or alternatively, the computerized device may authenticate the pairing between the remote device and the computerized device in response to detecting movement of the remote device according to a predefined gesture, as described above in reference to method 700. For example, upon determining that the remote device has been moved according to a predefined gesture associated with the computerized device, or a user account having access rights to connect with and/or control the computerized device, the computerized device may authenticate the pairing between the remote device and the computerized device. In this way, a user may authenticate themselves with the computerized device and/or begin controlling the computerized device using any remote device for which the relative orientation may be determined by the computerized device. Likewise, an authorized user need not enter any personal details (e.g., by logging into an application) in order to begin controlling the computerized device.

At block 812, an initial orientation of the remote device may be determined using the radio communications. The initial orientation of the remote device may be determined with respect to the computerized device, as described above, a real-world reference frame, and/or another reference frame of the environment within which the remote device and the computerized device are located. In some embodiments, the initial orientation may include information about the distance and direction from the remote device to the computerized device, or vice versa. Determining the orientation may include performing a ToF AoA/distance measurement and/or a PDoA orientation measurement, as described above in relation to method 600.

In some embodiments, determining the initial orientation includes determining that the remote device is in a predefined orientation. Predefined orientations may be with respect to the computerized device. For example, a predefined orientation associated with establishing a pairing with and/or initiating control of the computerized device by a mobile device, such as a smart phone, may be such that a vertical axis of the mobile device is substantially parallel with acceleration due to gravity and a horizontal axis passing through a screen of the mobile device is substantially parallel with a heading between the mobile device and the computerized device. As used herein, a determination that an axis is substantially parallel with a reference axis, vector, and/or heading may include a determination that the axis is within a threshold angular deviation of the reference axis, vector, and/or heading, such as within 5 degrees, 10 degrees, 15 degrees, and the like.

At block 816, movement of the remote device from the initial orientation according to a predefined gesture may be detected using the radio communications. As described above, a gesture may include one or more movements (e.g., translational and/or rotational), such as a clockwise or counterclockwise rotation around one or more axes, a movement along one or more axes, and the like. As further described above, detecting the movement of the remote device according to the predefined gesture may be performed using continuous ToF AoA/distance measurements and/or PDoA orientation measurements.

At block 820, a functionality of the computerized device may be controlled according to the predefined gesture. The predefined gesture may be associated with a functionality of the computerized device. For example, a computerized device for media playback, such as a smart speaker or display, may have unique gestures associated with each of a variety of media playback controls, such as advancing a currently playing track, adjusting an audio volume, playing/pausing the media playback, and the like. As another example, a vehicle may have unique gestures associated with a variety of remotely controllable functions, such as opening/closing a door, starting/stopping an engine, pulling out of a parking spot, and the like. In some embodiments, authenticating the pairing between the remote device and the computerized device, as described above, allows similar gestures to be used to control different devices. For example, while a single gesture may be associated with respective different functions of two computerized devices, an initial authentication (e.g., using a unique gesture) may allow each of the two computerized devices to determine when to act upon a gesture or ignore a gesture.

As described further herein, controlling the functionality of the computerized device in this way provides numerous benefits over existing technologies. For example, by using the computerized device to detect the orientation of the remote device, use of additional sensors (e.g., inertial measurement sensors) and/or specialized messages (e.g., including device orientation or pairing requests) by the remote device can be reduced. As such, the remote device itself can be less complex, in that the complexity of the electronics can be reduced by reducing the number of electronic components needed to communicate with the computerized device, and/or in that the complexity of the processor and any associated software or firmware installed on the remote device can be reduced to only that which is needed to transmit and receive the radio signals usable by the computerized device to determine its orientation and/or position.

As another example, by pairing with and/or controlling the computerized device based on the relative orientation of the remote device, the remote device can remain agnostic as to the types of computerized devices and their respective functionalities. Accordingly, as new computerized devices and/or new functionalities performable by existing computerized devices are developed, the remote devices capable of connecting with and/or controlling such devices need not be updated. Likewise, users need not rely on a specific device to control another device. For example, a user who has lost or misplaced their mobile device can instead use another person's mobile device (e.g., to unlock their car) without entering their personal information on the other person's device.

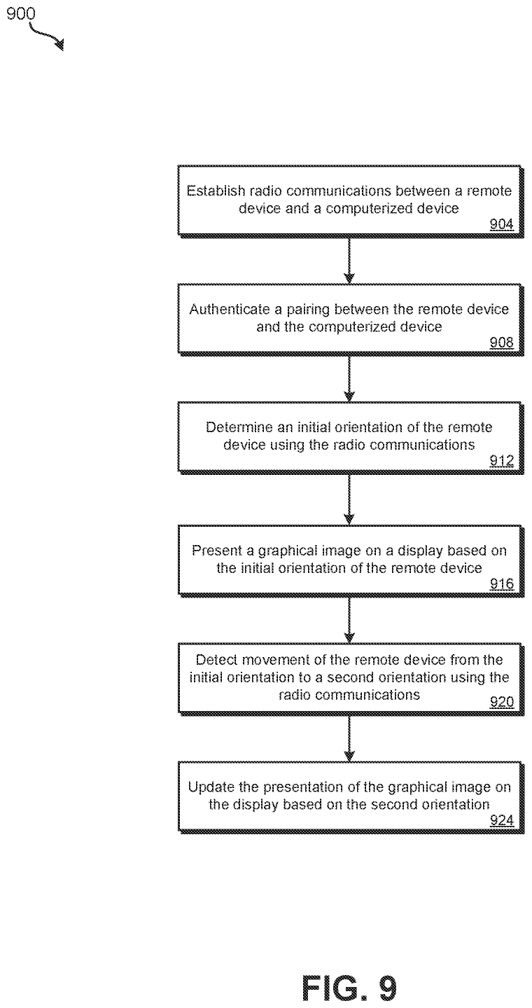

FIG. 9 illustrates an embodiment of a method 900 for updating a graphical display based on changes in orientation of a remote device. As described herein, method 900 may be useful for controlling augmented reality and/or virtual reality displays. Compared to existing technology, which may rely on more data intensive methods to track the movement of a remote device, such as using optical sensors and/or inertial sensors installed on a remote device, method 900 may allow for a simplified remote device design (e.g., including radio antennas). Method 900 may be performed using computerized device 200 or some other form of computerized device configured to determine the spatial relationship between itself and a remote device. However, it should be understood that either or both devices described in method 900 may be capable of determining the spatial relationship between the devices. Method 900 may optionally include some or all of the steps described above in relation to method 600 and/or method 700.

At block 904, radio communications may be established between the remote device and the computerized device. The remote device and the computerized device may be the same, or similar, devices as described above in relation to method 700. For example, the remote device may be a mobile device, such as a smartphone, smartwatch, headset display, and/or remote controller, and the computerized device may be a substantially stationary and/or fixed device, such as a smart television, smart speaker, hub device, game console, desktop or laptop computer, and the like.

Radio communications may be established as described above in relation to block 704 and/or block 708. For example, after determining that the remote device is within a threshold proximity of the computerized device, radio communications, such as UWB communications, may be established between the remote device and the computerized device. Additionally, or alternatively, radio communications may already be established as a result of executing a preceding method, such as method 700, or by initiating a pairing mode on the remote device, the computerized device, or both.

At block 908, a pairing between the remote device and the computerized device may be authenticated. Authenticating the pairing between the remote device and the computerized device may include verifying that the remote device, or a user account associated with a user of the remote device, is authorized to connect with and/or control the computerized device. For example, using the established radio communications (e.g., UWB communications), and/or one or more alternative types of wireless communication, such as WiFi, Bluetooth®, NFC, and the like, the remote device can transmit a device and/or user identifier to the computerized device for authentication. Additionally, or alternatively, the computerized device may authenticate the pairing between the remote device and the computerized device in response to detecting movement of the remote device according to a predefined gesture, as described above in reference to method 700. For example, upon determining that the remote device has been moved according to a predefined gesture associated with the computerized device, or a user account having access rights to connect with and/or control the computerized device, the computerized device may authenticate the pairing between the remote device and the computerized device.

At block 912, an initial orientation of the remote device may be determined using the radio communications. The initial orientation of the remote device may be determined with respect to the computerized device, as described above, a real-world reference frame, and/or another reference frame of the environment within which the remote device and the computerized device are located. In some embodiments, the initial orientation may include information about the distance and direction from the remote device to the computerized device, or vice versa. Determining the orientation may include performing a ToF AoA/distance measurement and/or a PDoA orientation measurement, as described above in relation to method 600.

In some embodiments, determining the initial orientation includes determining that the remote device is in a predefined orientation. Predefined orientations may be with respect to the computerized device. For example, a predefined orientation associated with establishing a pairing with the computerized device by a remote control device, such as a smart phone or headset display, may be such that a vertical axis of the device is substantially parallel with acceleration due to gravity a horizontal axis passing through a screen of the mobile device is substantially parallel with a heading between the mobile device and the computerized device, and the distance and direction from the device to the computerized device is such that the device is in a center of a room or surrounding environment.

At block 916, a graphical image may be presented on a display based on the initial orientation of the remote device. The graphical image may be an initial field of view (FOV) within a simulated environment. The simulated environment may be another location or environment in the real world, such as another city, an interior of a building, and the like, as previously captured using one or more visual recordings. Additionally, or alternatively, the simulated environment may be wholly or partially animated, as in the case of a video game environment. The display may be physically connected with the remote device, as in the case of a smartphone or headset display (e.g., an AR/VR headset), or the computerized device, as in the case of a more traditional video game experience in which a game console is integrated within or connected to a display device, such as a monitor or television.

At block 920, movement of the remote device from the initial orientation to a second orientation may be detected using the radio communications. As described above, detecting the movement of the remote device may be performed using continuous ToF AoA/distance measurements and/or PDoA orientation measurements. The motion of the remote device may be recorded at periodic or semi-periodic intervals depending on the desired accuracy and smoothness of rendering changes in the FOV of the graphical image. For example, in cases where increased accuracy and reduced lag are desired, such as online video game experiences, the position and orientation of the remote device may be updated at or close to the same frequency as the frame rate associated with the display being used to present the graphical image and/or a frame rate at which a processor can render updates to the graphical image.

At block 924, the presentation of the graphical image on the display may be updated based on the second orientation. For example, starting at the initial FOV of the graphical image or simulated environment, subsequent changes in the position and/or orientation of the remote device in the real-world may result in a corresponding change in the FOV of the simulated environment as though the remote device were moving through the simulated environment.

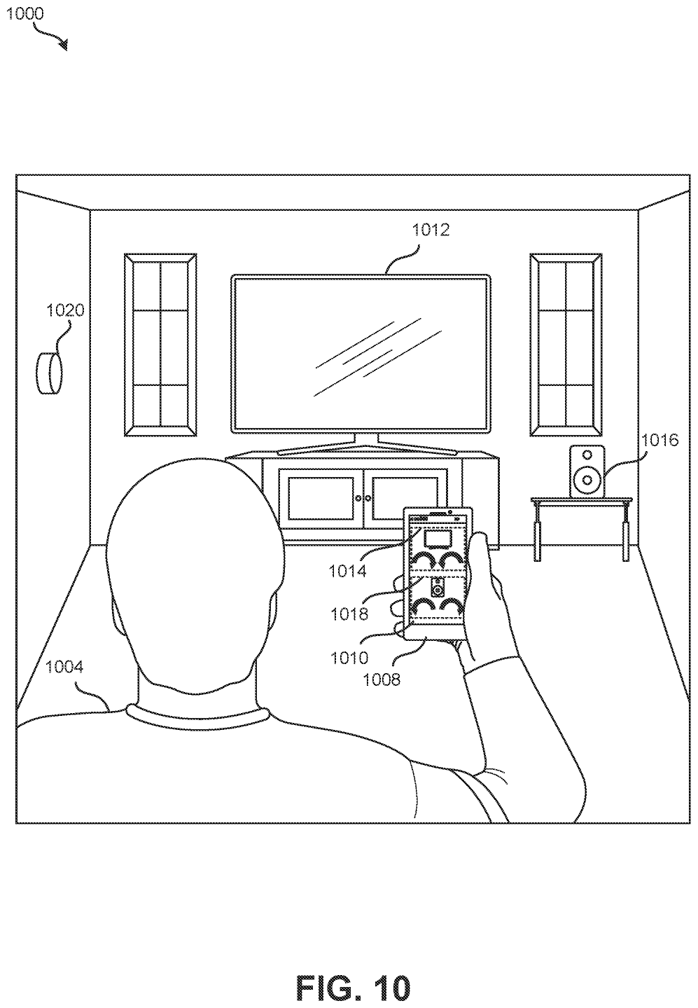

FIG. 10 illustrates an example of pairing a remote device with a computerized device in a smart home environment 1000 in accordance with some embodiments. As illustrated, user 1004 may wish to remotely control one or more computerized devices in and around environment 1000, such as smart thermostat 1020, display 1012, and/or smart speaker 1016, from their mobile device 1008. While not illustrated, environment 1000 may include additional devices, such as one or more hub devices, smart cameras, personal computing devices, and the like. Smart thermostat 1020, display 1012, and/or smart speaker 1016 may include the same, or similar, functionalities as computerized device 200 described above. For example, one or more of smart thermostat 1020, display 1012, and/or smart speaker 1016 may be configured to transmit and receive UWB messages useable to determine a distance and direction from the respective device to another device (e.g., a remote device and/or mobile device 1008) that is similarly UWB enabled as well as the relative orientation of the other device. As another example, the devices of environment 1000 may be remotely controllable and/or discoverable by receiving one or more types of wireless command signals (e.g., via a Wi-Fi, Bluetooth®, mesh network, etc.). Mobile device 1008 may include display 1010 configured to enable user 1004 to interact with mobile device 1008.

As further described above, after determining an initial orientation of mobile device 1008 (e.g., with a vertical axis substantially parallel with gravity, as illustrated), smart thermostat 1020, display 1012, and/or smart speaker 1016 may begin monitoring for a respective prescribed gesture associated with initiating control of the respective device. Additionally, or alternatively, smart thermostat 1020, display 1012, and/or smart speaker 1016 may begin monitoring for a prescribed gesture while mobile device 1008 is in a prescribed orientation, such as a rotation around an axis passing through display 1010 while the axis is substantially parallel with a heading between mobile device 1008 and the respective device.

In some embodiments, display 1008 presents instructions for performing the prescribed gesture based on computerized devices detected in environment 1000 that can be remotely controlled using the movement of mobile device 1008. For example, after establishing radio communications with each of display 1012 and smart speaker 1016, and/or upon determining that mobile device 1008 is in a predefined orientation associated with pairing to and/or controlling computerized devices, as described above, display 1010 may present first gesture instructions 1014 associated with initiating a paring between mobile device 1008 and display 1012 and second gesture instructions 1018 associated with initiating a pairing between mobile device 1008 and smart speaker 1016. In some embodiments, the gesture instructions are identified based on default gestures associated with a particular type of device. Additionally, or alternatively, gesture instructions may be received from each of the controllable devices upon establishing radio communications.

After detecting that mobile device 1008 has been moved according to first gesture instructions 1014, display 1012 may display an indication that a connection between mobile device 1008 and display 1012 has been established. Additionally, or alternatively, display 1012 may begin monitoring for subsequent predefined gestures associated with controlling one or more functionalities of display 1012, such as changing a channel, advancing a track, adjusting the volume, and the like.

To begin controlling a different remote device within environment 1000, such as smart speaker 1016, user 1004 may proceed to move mobile device 1008 according to second gesture instructions 1018. In some embodiments, upon detecting a gesture not associated with initiating a pairing or controlling a functionality of a respective device, the respective device may disregard subsequent gestures until the predefined gesture associated with the respective device is detected again. Additionally, or alternatively, gestures performed by mobile device 1008 while not in a predefined orientation, such as pointing at a previously paired device, may be disregarded by the previously paired device. While the detection of the prescribed gesture described above is associated with initiating control of a remote device, other embodiments are similarly applicable. For example, in response to detecting a prescribed gesture associated with a particular function of a respective device, the respective device may begin operating in accordance with the particular function.

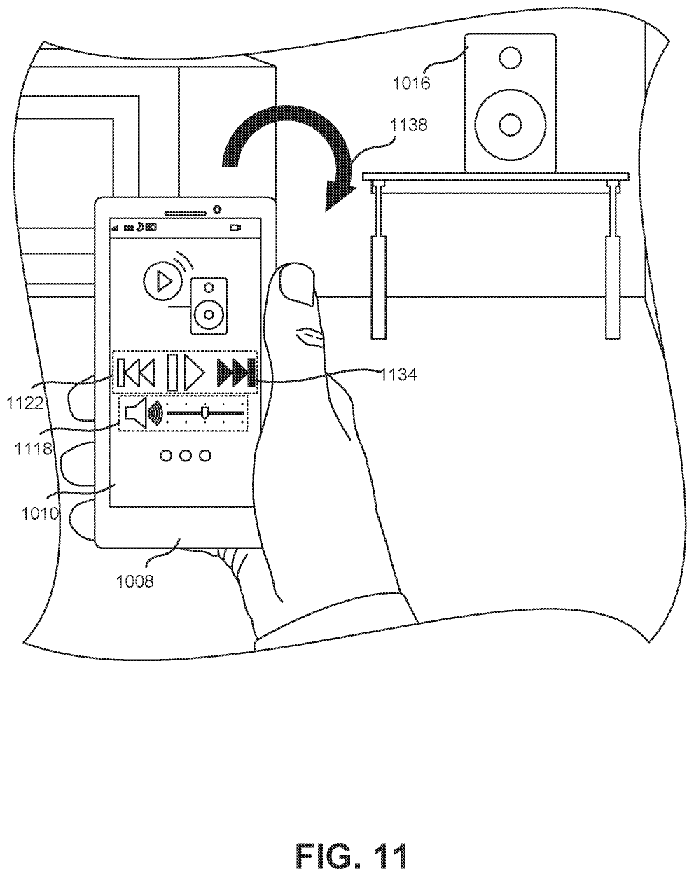

FIG. 11 illustrates an example of controlling a computerized device based on movement of a remote device in accordance with some embodiments. After establishing a connection with a computerized device, and/or detecting a prescribed gesture associated with a particular function of the computerized device, display 1010 may display one or more graphical user interfaces (GUIs) including one or more options for controlling the remote device. For example, as illustrated, display 1010 may present one or more options to control one or more operations of smart speaker 1016. In the illustrated example of controlling smart speaker 1016, the one or more options associated with smart speaker 1016 can include volume controls 1118 and media playback controls 1122. Mobile device 1008 may display similar options for other types of media playback devices, such as display 1012.

In response to detecting movement of mobile device 1008 according to a predefined gesture, such as clockwise rotation gesture 1138, associated with option 1134, media playback of a currently playing media track by smart speaker 1016 may be advanced to a subsequent media track. As described above, additional gestures may be associated with respective functionalities provided by smart speaker 1016.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A computerized device for determining relative orientation using radio communications, the computerized device comprising:
a housing comprising a first surface in a first plane;
a first antenna and a second antenna disposed within the housing and distributed along a first axis parallel to the first plane, wherein:
the first antenna and the second antenna are a same type; and
the first antenna and the second antenna are mirror oriented across a second axis perpendicular to the first axis and parallel to the first plane;
a processing system, comprising one or more processors, disposed within the housing, and in communication with the first antenna and the second antenna, wherein the processing system is configured to:
detect an arrival of a radio signal at the first antenna and the second antenna, wherein the radio signal is received from a remote device;
determine a phase difference of arrival (PDoA) between the arrival of the radio signal at the first antenna and the second antenna;
determine an angle of arrival (AoA) for the radio signal from the remote device to the computerized device;
determine a relative orientation of the remote device with respect to the computerized device using the PDoA and the AoA; and
output an indication of the relative orientation.

2. The computerized device for determining relative orientation using the radio communications of claim 1, wherein:
the first antenna and the second antenna both have a linear polarization;
the linear polarization of the first antenna is parallel with the linear polarization of the second antenna; and
the linear polarization is parallel to the first plane.

3. The computerized device for determining relative orientation using the radio communications of claim 1, wherein the first antenna and the second antenna are planar inverted-F antennas (PIFA).

4. The computerized device for determining relative orientation using the radio communications of claim 1, wherein:
the first antenna and the second antenna are ultra-wideband (UWB) antennas; and
the radio signal is a UWB message.

5. The computerized device for determining relative orientation using the radio communications of claim 1, wherein:
the first surface comprises an electronic display;
the housing further comprises a bezel joining the first surface to a second surface of the housing; and
the first antenna and the second antenna are disposed adjacent to the first surface between the electronic display and the bezel.

6. The computerized device for determining relative orientation using the radio communications of claim 1, wherein determining the relative orientation comprises identifying an orientation entry in a lookup table using the PDoA and the AoA as lookup keys.

7. The computerized device for determining relative orientation using the radio communications of claim 1, wherein determining the relative orientation comprises executing a machine learning model using the PDoA and the AoA as inputs.

8. The computerized device for determining relative orientation using the radio communications of claim 1, wherein the processing system is further configured to:
determine a type of the remote device, a distance from the computerized device to the remote device, or both; and
wherein determining the relative orientation further comprises using the type of the remote device, the distance from the computerized device to the remote device, or both.

9. The computerized device for determining relative orientation using the radio communications of claim 1, wherein the relative orientation comprises a rotation angle about a third axis perpendicular to the second axis and extending from the computerized device to the remote device.

10. The computerized device for determining relative orientation using the radio communications of claim 1, wherein the computerized device is selected from the group consisting of:
a tablet computer;
a laptop computer;
a hand-held gaming device; and
a smartphone.

11. A method of determining relative orientations between electronic devices, the method comprising:
detecting an arrival of a radio signal transmitted by a remote device at a first antenna and a second antenna of a computerized device, wherein:
the first antenna and the second antenna are a same type;
the first antenna and the second antenna are distributed along a first axis; and
the first antenna and the second antenna are mirror oriented across a second axis perpendicular to the first axis;
determining a phase difference of arrival (PDoA) between the arrival of the radio signal at the first antenna and the second antenna;
determining an angle of arrival (AoA) for the radio signal from the remote device to the computerized device;
determining a relative orientation of the remote device with respect to the computerized device using the PDoA and the AoA; and
outputting an indication of the relative orientation of the remote device.

12. The method of determining relative orientations between the electronic devices of claim 11, wherein the computerized device is in communication with a virtual reality display, and the method further comprises:
rendering, at the virtual reality display using the indication of the relative orientation, a virtual reality object with a same virtual orientation with respect to a perspective of the virtual reality display as the relative orientation of the remote device with respect to the computerized device.

13. The method of determining relative orientations between the electronic devices of claim 11, further comprising:
outputting instructions to a user of the computerized device to adjust the relative orientation of the remote device to achieve a second relative orientation; and
determining, by the computerized device, that the remote device is in the second relative orientation.

14. The method of determining relative orientations between the electronic devices of claim 11, wherein determining the relative orientation comprises identifying an orientation entry in a lookup table using the PDoA and the AoA as lookup keys.

15. The method of determining relative orientations between the electronic devices of claim 11, wherein determining the relative orientation comprises executing a machine learning model using the PDoA and the AoA as inputs.

16. The method of determining relative orientations between the electronic devices of claim 11, further comprising:
determining a type of the remote device, a distance from the computerized device to the remote device, or both; and
wherein determining the relative orientation further comprises using the type of the remote device, the distance from the computerized device to the remote device, or both.

17. A non-transitory processor-readable medium, comprising processor-readable instructions configured to cause one or more processors to:
detect an arrival of a radio signal transmitted by a remote device at a first antenna and a second antenna of a computerized device;
determine a phase difference of arrival (PDoA) between the arrival of the radio signal at the first antenna and the second antenna;
determine an angle of arrival (AoA) for the radio signal from the remote device to the computerized device;
determine a relative orientation of the remote device with respect to the computerized device using the PDA and the AoA; and
output an indication of the relative orientation of the remote device.

18. The non-transitory processor-readable medium of claim 17, wherein:
the first antenna and the second antenna are a same type;
the first antenna and the second antenna are distributed along a first axis; and
the first antenna and the second antenna are mirror oriented across a second axis perpendicular to the first axis.

19. The non-transitory processor-readable medium of claim 17, wherein the relative orientation is determined by identifying an orientation entry in a lookup table using the PDoA and the AoA as lookup keys.

20. The non-transitory processor-readable medium of claim 17, wherein the relative orientation is determined by executing a machine learning model using the PDoA and the AoA as inputs.
